(19) United States
(12) Patent Application Publication
(10) Pub. No.: US 2008/0123879 A1
(43) Pub. Date: May 29, 2008

(54) Digital wireless stereophonic music transmission device

(76) Inventor: Ming-Jen Cheng, Jhudong Township (TW)

Correspondence Address: PRO-TECHTOR INTERNATIONAL SERVICES, 20775 NORADA CT., SARATOGA, CA, 95070, US

(21) Appl. No.: 11/606,318

(22) Filed: Nov. 28, 2006

(51) Int. Cl. H04R 5/02

(52) U.S. Cl. 381/311

(57) ABSTRACT

A digital wireless stereophonic music transmission device includes a transmission module and a headphone. The transmission module includes a digital signal input device for receiving digital audio signals from an external digital music player, a stereophonic input device for receiving stereophonic signals from an external stereophonic music player, an analog/digital converter for converting the stereophonic signals into digital audio signals, and a signal transmitting module that receives digital audio signals from one of the digital signal input device and the analog/digital converter and then codes and transmits the signals received. The headphone includes a signal receiving module, an analog/digital converter, an amplifier, and at least one loudspeaker unit. The signal receiving module receives the signals from the signal transmitting module. The analog/digital converter of the headphone converts the signals received by the signal receiving module into analog audio signals that are output via the amplifier and the loudspeaker unit.

### BACKGROUND OF THE INVENTION

1. Field of the Invention

The present invention relates to a music transmission device and, more particularly, to a digital wireless stereophonic music transmission device.

2. Description of the Related Art

A typical digital wireless music transmission device includes a transmission module and a headphone. Digital audio signals are transmitted by the transmission module to the headphone for decoding and conversion into analog audio signals to be output to a loudspeaker unit for playing music.

However, conventional digital wireless music transmission modules can only receive digital audio signals from external music players. Namely, conventional digital wireless music transmission modules cannot receive stereophonic signals and, thus, cannot be used with stereophonic music players such as ipods, mobile phones, and PDAs with built-in MP3. Furthermore, conventional wireless music transmission modules do not have music players and, thus, can only played with headphones; namely, direct music playing by the transmission modules is not allowed.

### SUMMARY OF THE INVENTION

An objective of the present invention is to provide a digital wireless stereophonic music transmission device that integrates input functions of stereophonic signals and digital audio signals to allow reception of digital audio signals from televisions, computers, video recorders, and video games and to allow reception of stereophonic signals from ipods, mobile phones, and PDAs. The digital wireless stereophonic music transmission device is capable of playing stereophonic music by transmission and reception of digital audio signals in all orientation through wireless transmission.

A digital wireless stereophonic music transmission device in accordance with the present invention comprises a transmission module and a headphone. The transmission module includes a digital signal input device, a stereophonic input device, an analog/digital converter, and a signal transmitting module. The digital signal input device is adapted for receiving digital audio signals from an external digital music player. The stereophonic input device is adapted for receiving stereophonic signals from an external stereophonic music player. The analog/digital converter converts the stereophonic signals into digital audio signals. The signal transmitting module receives digital audio signals from one of the digital signal input device and the analog/digital converter and then codes and transmits the signals received.

The headphone includes a signal receiving module, an analog/digital converter, an amplifier, and at least one loudspeaker unit. The signal receiving module receives the signals from the signal transmitting module. The analog/digital converter of the headphone converts the signals received by the signal receiving module into analog audio signals that are output via the amplifier and the at least one loudspeaker unit.

In an example, the transmission module includes a housing having a recessed portion, and the stereophonic input device includes at least one connector mounted on a seat that is detachably mounted to the recessed portion of the housing.

In another example, the stereophonic input device (30) includes at least two connectors for respectively receiving two external stereophonic music players. The stereophonic input device further includes a switch for selectively controlling reception of stereophonic signals from one of the connectors.

Preferably, the transmission module further includes an amplifier and a loudspeaker unit for receiving and amplifying the stereophonic signals from the stereophonic input device.

Preferably, the signal transmission module includes a transmitting antenna for transmitting wireless dual carrier signals, and the signal receiving modules includes two receiving antennas for receiving the dual carrier signals.

Other objectives, advantages, and features of the invention will become more apparent from the following detailed description when taken in conjunction with the accompanying drawings.

### BRIEF DESCRIPTION OF THE DRAWINGS

FIG. 1 is a perspective view of a digital wireless stereophonic music transmission device in accordance with the present invention.

FIG. 2 is a schematic block diagram of the digital wireless stereophonic music transmission device in FIG. 1.

FIG. 3 is a perspective view of a transmission module of the digital wireless stereophonic music transmission device in FIG. 1.

FIG. 4 is a rear view of the transmission module in FIG. 3.

FIG. 5 is a partly exploded view illustrating an alternative example of the transmission module.

FIG. 6 is a perspective view similar to FIG. 1, illustrating use of the digital wireless stereophonic music transmission device in accordance with the present invention.

### DETAILED DESCRIPTION OF THE PREFERRED EMBODIMENTS

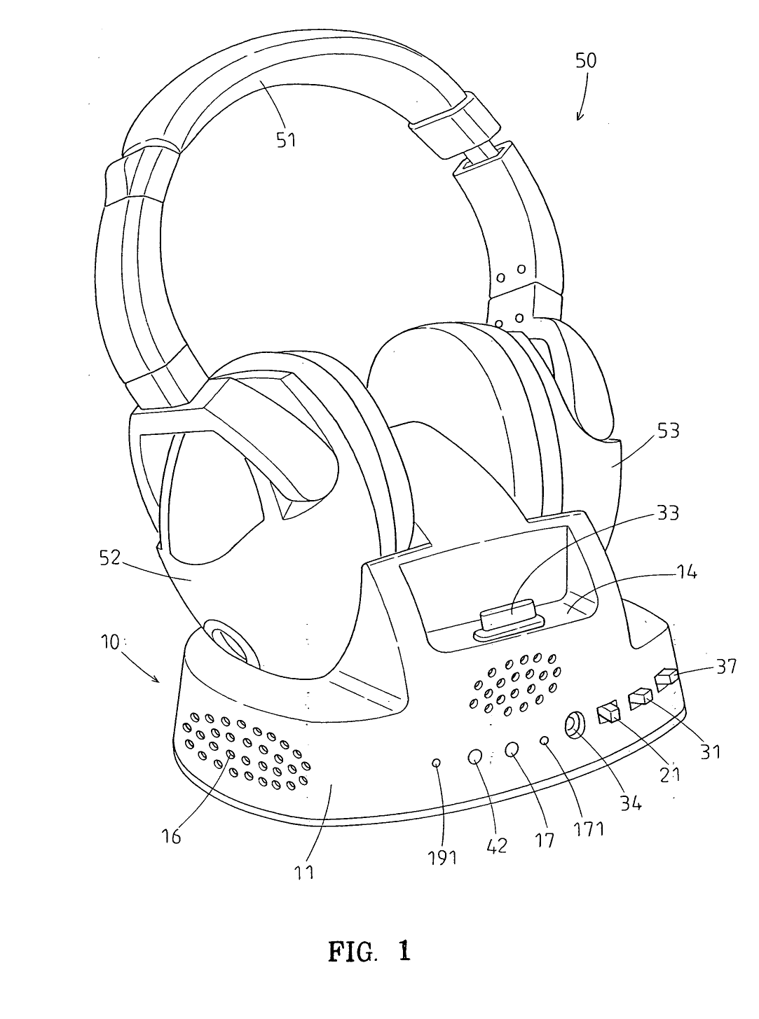

Referring to FIGS. 1 through 3, a digital wireless stereophonic music transmission device in accordance with the present invention comprises a transmission module 10 and a headphone 50. The transmission module 10 includes a plastic housing 11 and two recessed positioning sections 12 and 13 on opposite sides thereof. The headphone 50 includes a headband 51 and left and right housings 52 and 53 on two ends of the headband 51. When not in use, the housings 52 and 53 of the headphone 50 are placed in the positioning sections 12 and 13 of the transmission module 10.

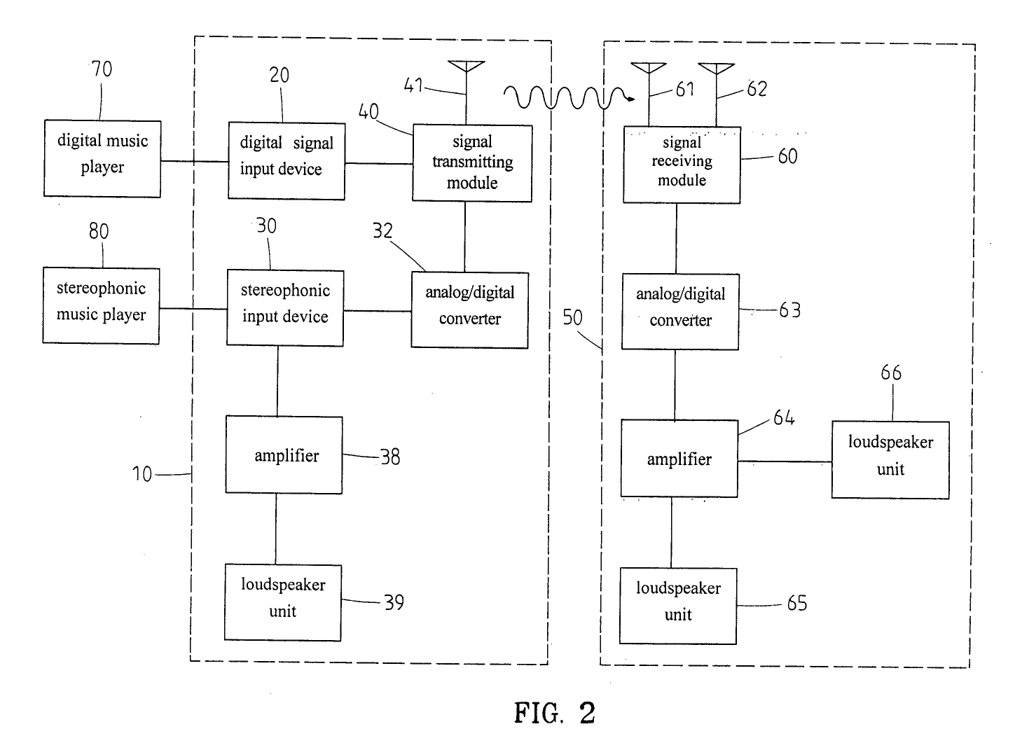

With reference to FIG. 2, the transmission module 10 includes a digital signal input device 20, a stereophonic input device 30, an analog/digital converter 32, and a signal transmitting module 40. The digital signal input device 20 receives digital audio signals from an external digital music player 70. The stereophonic input device 30 receives stereophonic signals from an external stereophonic music player 80, which stereophonic signals are converted into digital audio signals by the analog/digital converter 32. The signal transmitting module 40 receives digital audio signals from one of the digital signal input device 20 and the analog/digital converter 32 for subsequent coding and transmitting digital signals via 2.4 GHz FSK (frequency shifting keying).

The headphone 50 includes a signal receiving module 60, an analog/digital converter 63, an amplifier 64, and at least one loudspeaker unit (two loudspeaker units 65 and 66 in this example). The signal receiving module 60 receives digital signals from the transmission module 10, which digital signals are converted by the analog/digital converter 63 into true analog audio signals or simulative 6-channel analog audio signals, which, in turn, are output via the amplifier 64 and the loudspeaker units 65 and 66, thereby playing 5.1 channel stereophonic music.

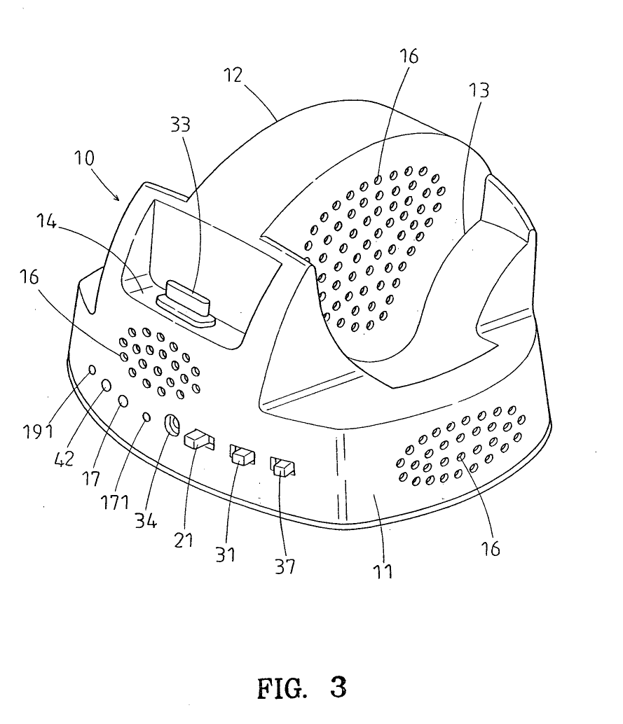

With reference to FIGS. 1 and 3, a battery type power source may be mounted in each of the transmission module 10 and the headphone 50. The transmission module 10 may further include a power switch 17, a power indicator lamp 171, a DC power socket 18, a charging socket 19, and a charging indicator lamp 191.

On a rear side of the housing 11 of the transmission module 10, the digital signal input device 20 includes input/output connectors 22 and 23 for digital-signal optical fiber. The digital signal input device 20 further includes a coaxial input connector 24 for digital signals on the rear side of the housing 11. Further, a switch 21 is provided on a front side of the housing 11 for controlling selective input of signals from one of the digital signal input device 20 and the stereophonic input device 30.

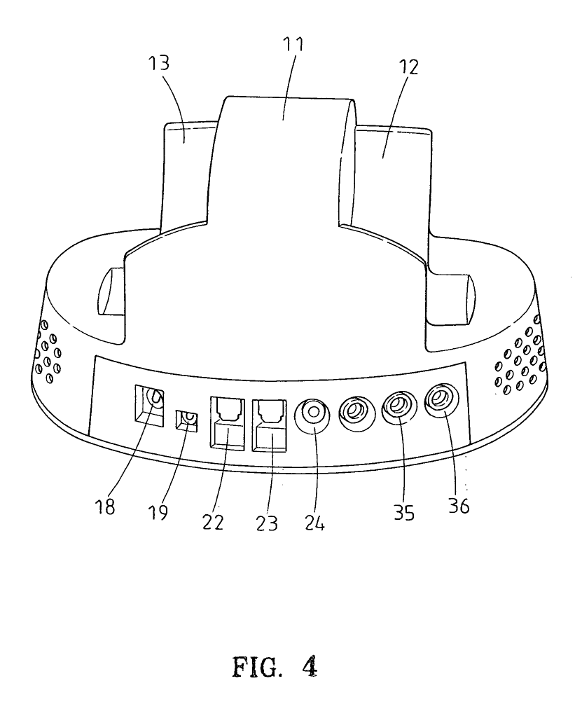

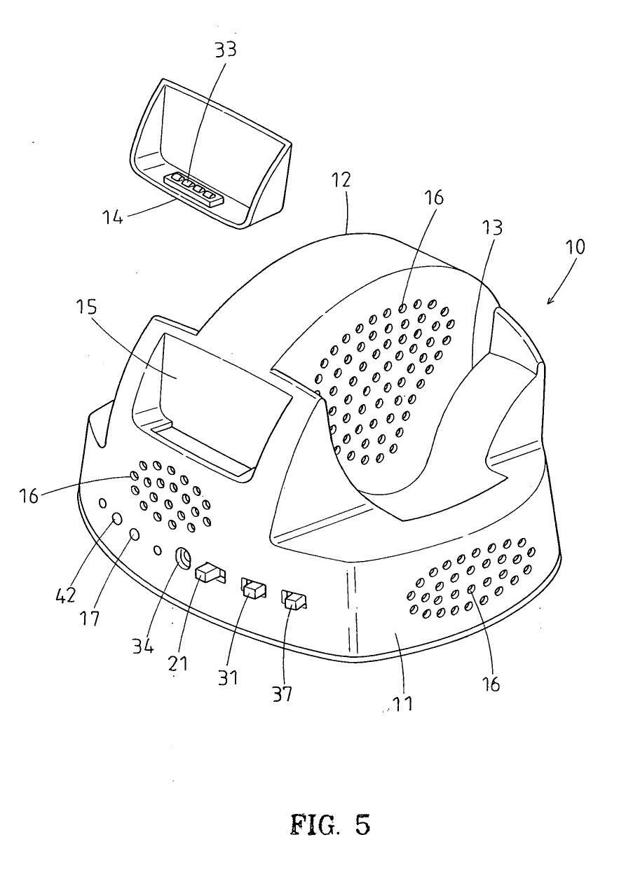

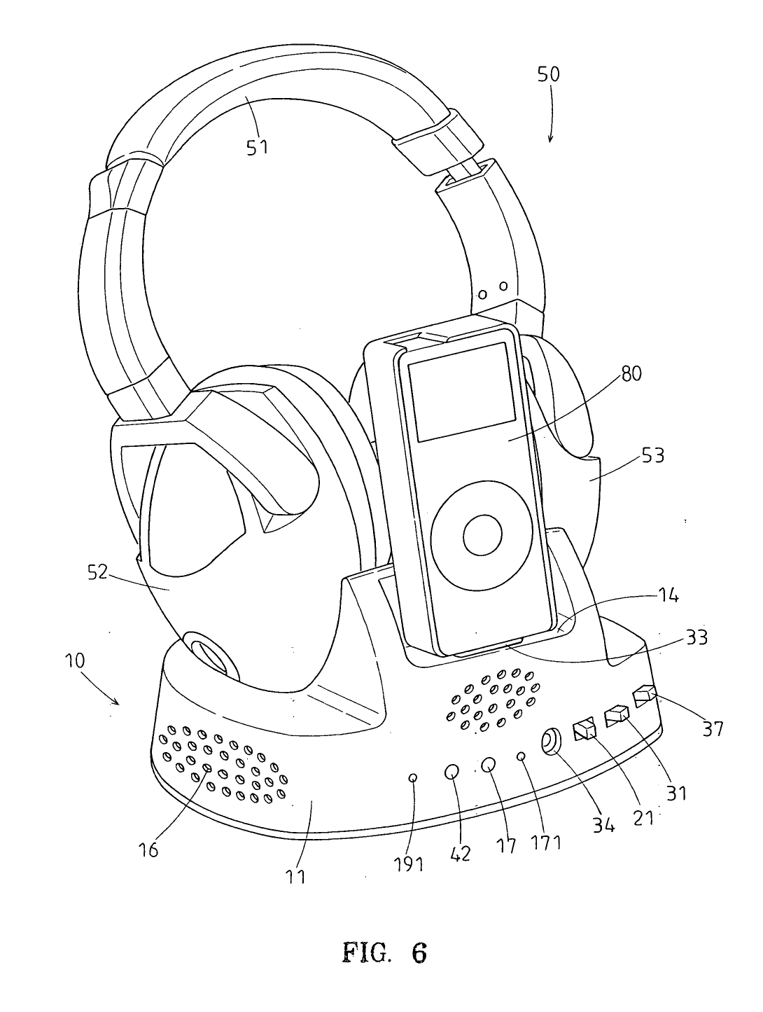

With reference to FIGS. 1 and 2, the stereophonic input device 30 includes at least one connector (two connectors 33 and 34 in this example) each of which is connected to an associated external stereophonic music player 80 (such as an ipod, mobile phone, or PDA with built-in MP3, see FIG. 6) for receiving stereophonic signals. A switch 31 is provided for selectively controlling reception of stereophonic signals from one of the connectors 33 and 34. The stereophonic input device 30 may further include two stereophonic input connectors 35 and an output connector 36 (see FIG. 4). The connector 33 may be directly provided on an integral seat 14 of the housing 11. In an alternative example shown in FIG. 5, the seat 14 can be detached from the housing 11 or mounted to a recessed portion 15 of the housing 11.

The transmission module 10 further includes an amplifier 38 and a loudspeaker unit 39. Sound holes 16 and a switch 37 are provided to control output of stereophonic signals from the stereophonic input device 30 to the amplifier 38 or the analog/digital converter 32. Hence, the amplifier 38 may receive and amplify the stereophonic signals from the stereophonic input device 30 and play music via left and right speakers (not shown) and woofer (not shown) of the loudspeaker unit 39.

With reference to FIG. 2, the signal transmission module 40 includes a transmitting antenna 41 for transmitting wireless dual carrier signals whereas the signal receiving modules 60 includes two receiving antennas 61 and 62 for receiving the dual carrier signals, thereby achieving transmission and reception of digital audio signals in all orientation.

The present invention integrates input functions of stereophonic and digital audio signals to allow reception of digital audio signals from televisions, computers, video recorders, and video games and to allow reception of stereophonic signals from iPods, mobile phones, and PDAs. The digital wireless stereophonic music transmission device in accordance with the present invention is capable of playing stereophonic music by transmission and reception of digital audio signals in all orientation through wireless transmission.

Although specific embodiments have been illustrated and described, numerous modifications and variations are still possible. The scope of the invention is limited by the accompanying claims.

What is claimed is:

1. A digital wireless stereophonic music transmission device comprising:
a transmission module (10) including a digital signal input device (20), a stereophonic input device (30), an analog/digital converter (32), and a signal transmitting module (40), the digital signal input device (20) being adapted for receiving digital audio signals from an external digital music player (70), the stereophonic input device (30) being adapted for receiving stereophonic signals from an external stereophonic music player (80), the analog/digital converter (32) converting the stereophonic signals into digital audio signals, the signal transmitting module (40) receiving digital audio signals from one of the digital signal input device (20) and the analog/digital converter (32) and then coding and transmitting the digital audio signals received; and
a headphone (50) including a signal receiving module (60), an analog/digital converter (63), an amplifier (64), and at least one loudspeaker unit (65, 66), the signal receiving module (60) receiving the signals from the signal transmitting module (40), the analog/digital converter (63) of the headphone (50) converting the signals received by the signal receiving module (60) into analog audio signals that are output via the amplifier (64) and said at least one loudspeaker unit (65, 66).

2. The digital wireless stereophonic music transmission device as claimed in claim 1 wherein the transmission module (10) includes a housing (11) having a recessed portion (15), and wherein the stereophonic input device (30) includes at least one connector (33) mounted on a seat (14) that is detachably mounted to the recessed portion (15) of the housing (11).

3. The digital wireless stereophonic music transmission device as claimed in claim 1 wherein the stereophonic input device (30) includes at least two connectors (33 and 34) for respectively receiving two external stereophonic music players, and wherein the stereophonic input device (30) further includes a switch (31) for selectively controlling reception of stereophonic signals from one of the connectors (33 and 34).

4. The digital wireless stereophonic music transmission device as claimed in claim 1 wherein the transmission module (10) further includes an amplifier (38) and a loudspeaker unit (39) for receiving and amplifying the stereophonic signals from the stereophonic input device (30).

5. The digital wireless stereophonic music transmission device as claimed in claim 1 wherein the signal transmission module (40) includes a transmitting antenna (41) for transmitting wireless dual carrier signals, and wherein the signal receiving modules (60) includes two receiving antennas (61 and 62) for receiving the dual carrier signals.
